(19) United States
(12) Patent Application Publication
(10) Pub. No.: US 2007/0142931 A1
(43) Pub. Date: Jun. 21, 2007

(54) ELECTRONIC MODULE ARRANGEMENT FOR CLOTH WASHING MACHINES

(75) Inventor: Wagner Roberto Peral, Sao Paulo-SP (BR)

Correspondence Address: WOLF, BLOCK, SHORR AND SOLIS-COHEN LLP, 250 PARK AVENUE, 10TH FLOOR, NEW YORK, NY, 10177, US

(73) Assignee: TECHINVEST LTDA, Sao Paulo-SP (BR)

(21) Appl. No.: 11/419,045

(22) Filed: May 18, 2006

(30) Foreign Application Priority Data
Nov. 25, 2005 (BR) PI 0505228-9

(51) Int. Cl. G05B 11/01

(52) U.S. Cl. 700/19

(57) ABSTRACT

“ELECTRONIC MODULE ARRANGEMENT FOR CLOTH WASHING MACHINES” constituted by an electronic control module (6) with its components separately installed from the electronic power module (2), however keeping conventional links between both boards and the mechanic components of the cloth washing machine, so that, with such configuration, the electronic power module (2) may be independently substituted, in case of damage, bringing in benefits for repair services and less stock costs, since no storage of full frontal panels, i. e. panels including control modules (6), will be required, while, in the assembly stage, the washing machine may be almost fully produced with no interruptions in the serial production line, just keeping the installation point in the control module (6) preserved, which will then be clipped in configuration according to higher demand, as felt by retail outlets.

The present description refers to an invention patent application for a set of electronic modules for a cloth washing machine, which is now produced in two different modules, i. e. the module formed by the electronic control board (by which programming and the current conditions of the machine are effected and shown, which programming can be seen by the user by means of leds and/or various graphic signs, effected by means of buttons and/or levers) and the electronic power module (responsible for the control of operation of valves, motor and further basic elements of the machine).

The separation between the two electronic modules will exceptionally speed up the operation, especially concerning technical procedures related to maintaining and repairing said washing machines, be it in specialized stores or not, allowing, in case the electronic power module (more commonly damaged) becomes useless, its simple substitution, independently from the rest of the control module.

Also in the assembly stage, significant advantages can be noticed thanks to the separation, since the electronic control module (assembled in various configurations) may be separately installed in a last assembly operation, in the almost ready machine, following the demand for a given configuration of the front panel, which demand is felt from retail outlets.

Concerning stock, the system will cause considerable reduction over the usually incurred cost from the need of keeping a large number of full front panels, since the standardization of the electronic power module will enable it to be universally used, meeting various models of washing machines, independently from the other elements of the control module.

### STATE OF THE ART

Experts in the art and even users know that the operation and timing of current cloth washing machines, as well as other household appliances, are controlled by electronic commands.

Such control is especially used in cloth washing machines, which, by means of a front panel, have the full washing cycle programming synchronized with motor operation to operate water inlet and outlet valves.

Currently, the front panel stores in a single piece the electronic circuit board, made by two different circuits assembled on a board for the electronic control of programming—in interface with the user, it allows him/her to visually follow the full cloth washing cycle, and the electronic power board, which is itself interconnected with the mechanical parts of a washing machine, controlling the operation of the motor and water inlet and outlet valves, after programming is concluded.

A conventional circuit board is currently covered, with all its electronic parts, by a resin incorporating to the structure forming the front panel, which may be clipped by its teeth to corresponding fixtures existing on the machine, thus being frontally located for the user to effect programming and visually follow the full washing cycle.

The construction of said front panel in a single part is however troublesome, since the electronic power module is frequently burnt, be it for wrong use by the user, undesirable energy peaks or other problems which affect its sensible electronic components.

In these cases, by means of specialized repair service (in connection to the period of guarantee as offered by the store where the machine was purchased) or by specialized professionals, the front panel containing both integrated electronic sets should be fully taken out and substituted by a new panel, which is a difficult operation and consequently generates high cost and more labor work.

The situation gets worse since, in the stocks of these sale points, there should therefore be various different units of such full front panels (i. e. conventional panels containing both integrated electronic boards—control board and power board), according to each model.

Another related question is the commercial concern on the service at retail outlets, where a given type of machine starts to have more demand, which is frequently determined by the offered features as shown on the front panel.

The lack of supply according to the demand is linked to the fact that, in the assembly line, a sequence of already finished machines is produced with a given type of front panel. In further details, various models of machines are assembled with various configurations for their front panels and, after shown, more or less demand may be observed for a given model, which demand is many times, as stated, defined by the configuration of the control module.

In case the model in production needs substitution for a model with higher demand at that moment, the full project to a new electronic set is required, which demands time and high costs for the production of the front panel, generating sale losses.

### OBJECT OF THE PATENT

The subject of the patent at issue proposes a set formed by an electronic control module with its components separately installed from the electronic power module, however keeping conventional links between both boards and the mechanical parts of the cloth washing machine.

With such arrangement, the power module may be independently substituted in case of damage, bringing in benefits for repair service and less stock costs, since no fill front panels will be required, i. e. panels also with control modules, in storage. In assembling, the washing machine may be produced almost as fully built in, with no interruptions in the serial production line, just preserving the point of installation of the control module, which will then be clipped in configuration according to higher demand, as felt by retail outlets.

Therefore, the objects of the system are: to make the job easier for repair service (in case of damages) by just substituting the power module, stock of the power module only and no longer of the full front panel and continuous production line for washing machines, thanks to the possibility of installing the control module in a last stage, according to the configuration with higher demand in terms of sales.

Having been superficially explained, the system is now better detailed by means of the attached figures, in which we can see:

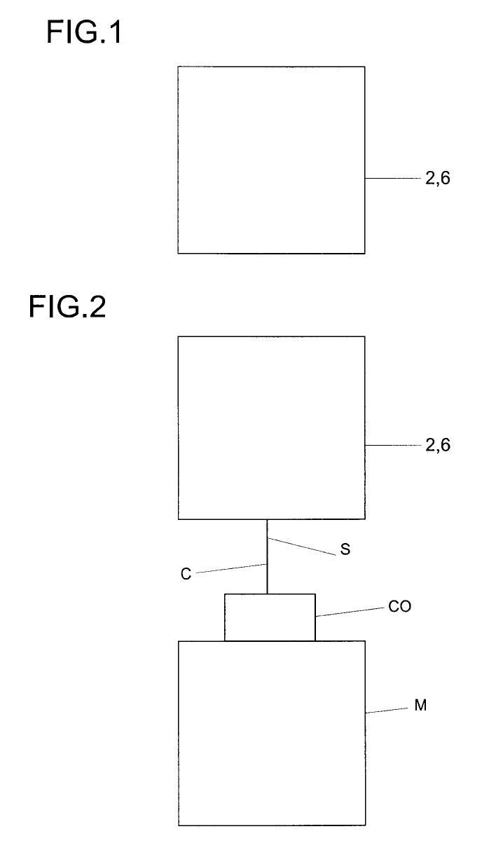

FIG. 1—scheme showing current electronic set methods (front panel) of washing machines, in use in a single module, comprising all electronic components i. e. integrated electronic control module and power module;

FIG. 2—scheme showing current electronic set methods (front panel) in use, separated into two modules, one assembling the control module and the power module (including valves) and the other module just to control the motor (M). In this case., connectors (CO) of the motor (M) control module have non-standard electric signals (S), i. e. their interconnections are unified by a whip (C) with non-standard signals to the first module;

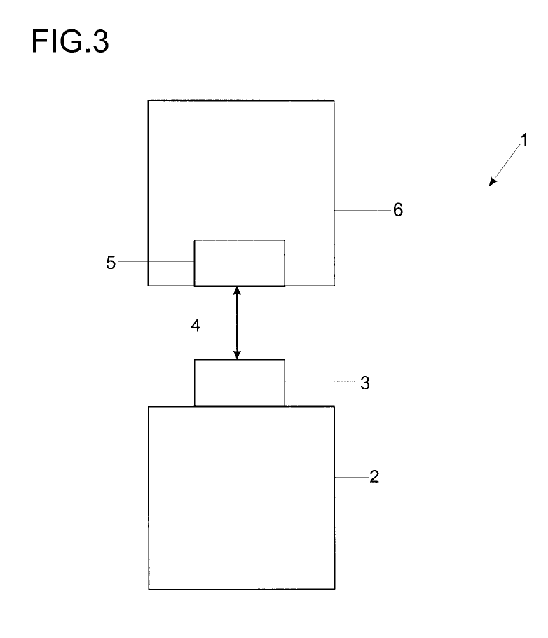

FIG. 3—scheme showing the proposed system with the standard power module, including valve controls and motor, the standard connector with standard electric signals to be used in various washing machine models. The control module is especially projected for each model of washing machine, but with standardized electric signals out for integration to the power module.

According to the attached drawings, the “ELECTRONIC MODULE ARRANGEMENT FOR CLOTH WASHING MACHINES” object of the present invention patent application is constituted by an electronic set (1) developed to control programming and features of cloth washing machines, being said set formed by a power module (2) to control motor operation and water inlet and outlet valves to/from the cloth washing machine, said module (2) including a connector (3) with electric signals which are compatible with various models of said machines.

The electronic power module (2) is connected by a whip (4) to the outlets (5) with standard electric signals from the electronic control module (6), which is, on the other hand, projected in a special configuration according to given models of washing machines, said module (6) including inlets and outlets for leds, buttons and/or levers or incorporated leds, as well as valve and motor controls.

Thus constituted, the set formed by two independent but interconnected electronic modules (2) and (6) will allow great flexibility of procedures over cloth washing machines, speeding up repair service systems, stock and assembling.

In repair service procedures, in case of burnt or other eventually occurred damages to the electronic power board (2), it may be easily taken off and substituted with no need to substitute the whole electronic set. The possibility of use of one single power module (2) for various models of washing machines is important, since it will allow to decrease the cost in substitution of defective modules, since in that module (2) main problems occur, thus also avoiding the substitution of the control module (6), which is more expensive and with less possibility of being damaged.

In in loco repair services, the expert may have a power module (2) in his purse promptly meeting a wide range of washing machine models.

Such “universalization” sets up the stock just of units of the electronic power module (2), thus avoiding higher costs for authorized stores, since the possibility of use of one single type of electronic power module (2) will reduce the costs for stock maintenance, avoiding the job of keeping expensive electronic units (full electronic modules) for each model of washing machine.

Finally, concerning assembly, the system also allows to manufacture fully built washing machines, already assembled by the supplier, being such machines therefore provided with the electronic power board (2) fully interconnected to electronic components, however keeping the installation point of the electronic control board (6) intact. Therefore, the assembler can simultaneously produce batches of the electronic control board (6) under various configurations.

Therefore, according to the demand, as seen by retail outlets, for a given type of machine, it may receive the electronic control module (6) in greater demand in series, in terms of configuration, not interrupting the industrial production of said washing machines.

1. “ELECTRONIC MODULE ARRANGEMENT FOR CLOTH WASHING MACHINES” constituted by an electronic set (1) developed to control programming and features of cloth washing machines, being said set formed by a power module (1) to control motor operation and water inlet and outlet valves to/from the cloth washing machine, interconnected to an electronic control module (6) including inlets and outlets for leds, buttons and/or levers or incorporated leds, as well as valve and motor controls, wherein said module (2) including a connector (3) with standard electric signals, compatible with various models of machines, being connected by a whip (4) to the outlets (5) with standard electric signals from the electronic control module (6), projected, on the other hand, in special configuration according to given models of washing machines.

2. “ELECTRONIC MODULE ARRANGEMENT FOR CLOTH WASHING MACHINES of claim 1, wherein the electronic power module (2) and control module (6) having their respective components separately installed, however keeping links between both boards and the mechanical parts of the cloth washing machine.

3. “ELECTRONIC MODULE ARRANGEMENT FOR CLOTH WASHING MACHINES” of claim 1, bringing in facilities and cost reduction for repair service procedures and stocking of said control and electronic operation components for washing machines, wherein the substitution of just the electronic power module (2), in case of damage, which is easily and independently taken off and substituted, with no need to substitute the whole electronic control set.

4. “ELECTRONIC MODULE ARRANGEMENT FOR CLOTH WASHING MACHINES” of claim 1, allowing the continuous production of almost fully built cloth washing machines, as already assembled by the supplier, being said machines provided with an electronic power board (2) duly interconnected to electronic components, however keeping intact the point of installation of the electronic control board (6), wherein the installation of the electronic control (6) in the last stage of assembly, in various configurations, following the demand as felt by retail outlets.
